(19) United States
(12) Patent Application Publication
(10) Pub. No.: US 2008/0230089 A1
(43) Pub. Date: Sep. 25, 2008

(54) AQUEOUS WASHING SYSTEM AND METHOD

(76) Inventor: Paul Robert Young, Solihull (GB)

Correspondence Address: GAUTHIER & CONNORS, LLP, 225 FRANKLIN STREET, SUITE 2300, BOSTON, MA, 02110, US

(21) Appl. No.: 11/860,604

(22) Filed: Sep. 25, 2007

(30) Foreign Application Priority Data
Mar. 19, 2007 (GB) 0705220.2

(51) Int. Cl. B08B 3/04; B08B 3/08

(52) U.S. Cl. 134/2; 134/186; 134/105; 134/119; 134/147; 134/111; 134/95.2; 134/95.1; 134/115 R; 134/109; 134/57 R; 134/25.1

(57) ABSTRACT

An aqueous washing system and method of operation for washing of articles such as engineering components, including curing of resin impregnated porous metal components, comprising placing the articles into a process chamber (10) and supplying from a supply tank (11) an aqueous washing fluid at a temperature at or above 100° C. A head of pressure is established above the fluid in tank (11) whereby the fluid may be transferred by a pump (P1) to the process chamber (10). After a washing cycle the articles are rinsed by clean water and then vacuum dried before removal from the process chamber (10).

### PRIORITY INFORMATION

This application claims priority to United Kingdom Patent Application No. 0705220.2, filed on Mar. 19, 2007 all of which is incorporated herein in its entirety.

### BACKGROUND OF THE INVENTION

1. Field of the Invention

This invention concerns a system for, and method of, washing and degreasing articles such as metal engineering components. To ensure optimum performance and appearance of products and components, effective cleaning and drying has become a major concern in the engineering industry.

2. Brief Description of the Art

Difficult soils such as heavy greases and oils, zinc stearate, lapping pastes, adhesive residues and the like are conventionally removed from articles using either strong alkaline detergents which can adversely affect or even destroy some metal substrates, or solvent based cleaners such as trichloroethylene. Both of these present environmental and health and safety problems and should be avoided wherever possible. The present invention, on the other hand, is concerned with washing systems using aqueous solutions at elevated temperature thus to dissolve and break down difficult soils without using harmful solvents or corrosive chemicals. Aqueous solutions used at high temperature will reduce viscosity and surface tension of the wash solution which ensures complete penetration of small cavities in the articles being washed, and the high thermal energy of the solution serves to soften and break down tenacious soils.

### SUMMARY OF THE INVENTION

It is therefore an object of the present invention to provide an improved aqueous washing system and a method of operating such a system to ensure thorough cleaning and drying of articles to be washed.

According to the present invention there is provided an aqueous washing system comprising a process chamber for receiving articles to be washed, a supply tank to contain a heated aqueous washing fluid, a pump and pipework to transfer the fluid from the supply tank to the process chamber, and means to establish a head of pressure over the fluid in the supply tank, sufficient to enable the pump to transfer the fluid at a temperature of at least 100° C.

Means may be provided for heating the washing fluid in the supply tank to a temperature at or above 100° C.

Means may be provided for rotating or agitating articles within the process chamber.

Valved pipework may be provided to return the washing fluid from the process chamber to the supply tank.

A filter may be provided to remove contaminants from the washing fluid prior to its return to the supply tank.

A stored supply of compressed air may be valve-connected to the supply tank to maintain the head of pressure in the tank.

A vacuum pump may be provided to effect vacuum drying of articles within the process chamber.

A supply of aqueous rinsing fluid may be connected to the process chamber.

A cold water header tank may be valve connected to the supply tank.

A vapour condenser may be associated with the header tank.

Means may be provided to control the temperature of the cold water in the header tank.

An aqueous fluid recycling system may be connected to the supply tank to remove contaminants from the washing fluid.

The washing system may include automatic timing and control means to effect cyclic operation of the system, and adjustable to suit the articles to be washed and the constituents of the washing fluid.

Further according to the present invention there is provided a method of aqueous washing of articles in a process chamber comprising the steps of providing a supply of aqueous washing fluid in a supply tank, heating the fluid in the supply tank, establishing a head of pressure over the fluid in the supply tank and pumping the fluid from the supply tank to the process chamber at a temperature of at least 100° C. to wash articles therein.

When pumping the washing fluid from the supply tank to the process chamber a positive pressure may be established within the process chamber, the positive pressure being vented back into the storage tank to produce the head of pressure necessary to pump the fluid at over 100° C.

The articles may be rotated or agitated in the process chamber during a washing cycle.

The washing fluid may be returned to the supply tank after a washing cycle.

A washing cycle may be repeated a plurality of times, each time pressurising the supply tank, pumping the fluid to the process chamber, washing the articles in the process chamber, and returning the fluid to the supply tank.

Rinsing fluid may be supplied to the process chamber after the or each washing cycle is completed.

The articles may be vacuum dried in the process chamber.

The washing fluid may be filtered to remove contaminants prior to its return to the supply tank.

At least a portion of the washing fluid may be transferred to a recycling system for removal of contaminants, and returned to the supply tank.

The washing fluid may contain at least one high-temperature, low-foam surfactant, at least one corrosion inhibitor and at least one multi-metal passivator.

The washing fluid may contain at least one water-soluble vapour pressure modifier.

The washing fluid may contain at least one viscosity and surface tension reducer.

### BRIEF DESCRIPTION OF THE DRAWING

FIG. 1 illustrates an aqueous washing system.

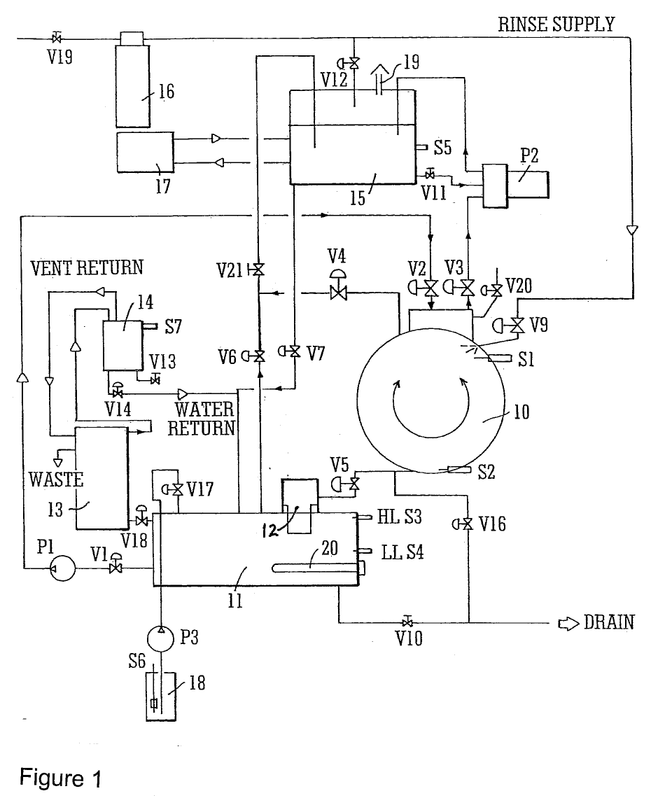

### DETAILED DESCRIPTION OF THE INVENTION

An embodiment of the invention will now be described, by way of example only, with reference to the accompanying drawing which schematically illustrates an aqueous washing system in accordance with the invention.

The system comprises a process chamber (10) having a sealed access door (not shown) and means within the chamber to support one or more articles to be washed. The support means, and thus the article or articles to be washed, are continuously rotated during a washing cycle to ensure that the washing fluid is thoroughly applied to all parts of the article. Alternatively, or in addition, the support means may be oscillated or remain static within the chamber.

A supply tank (11) is adapted to contain heated washing fluid to be supplied to the process chamber, and a filter (12) is provided to remove contaminants from fluid returned to the tank from the process chamber (10).

An aqueous fluid recycling system (13) is connected to the supply tank (11) to treat the washing fluid, removing contaminants therefrom and recovering the fluid for re-use. The system (13) is connected to a water recovery tank (14).

A cold water header tank (15) supplies top up water to the supply tank (11), and a supply (16) of pure rinsing water is connected to the process chamber (10). Cold water in the header tank (15) is maintained at the required temperature by a chiller (17).

A drum (18) containing chemical constituents for the washing fluid is also connected for the supply of such chemicals to the supply tank (11).

The system is completed by a series of shut off and control valves V1 to V7, V9 to V14 and V16 to V21, pumps P1 to P3 and level sensors S1 to S7 which, together with associated pipework, serve to enable operational control of the system as will be described. An automatic timing and control means (not shown) is provided to effect cyclic operation of the system and is adjustable to suit the articles to be washed and the condition and constituents of the washing fluid.

The system operates according to the following method sequence.

### Stand-by Mode

In a stand-by mode process chamber valves V2, V3, V4, V5, V9, V16 and V20 are closed, as are supply tank valves V6, V7 and V17. In this mode the process chamber (10) is empty and the supply tank (11) is filled to the level of sensor S3 with an aqueous washing fluid including blends of high temperature, low foam surfactants such as nonionic surfactants with molecular weight of greater than 7000, for example, ethoxylated alkyl phenols, ethoxylated dialkyl phenyl ethers or alkyl ether carboxylic acids. Other examples include polyoxyethylene sorbitan monooleates, biodegrable alcohol ethoxylates, amino ethylene phosphonic acids and modified polyethoxylated alcohol. Some of these surfactants may have a volatile re-usable fraction while others may function as viscosity and surface tension modifiers and/or vapour pressure modifiers.

The washing fluid also contains a blend of corrosion inhibitors and multi-metal passivators which protect metal articles from darkening, discolouration and oxidation during the high temperature washing process. Some of these may be volatile and their intrinsic volatility enables the inhibition to operate within the solution phase at up to 100° C. and also within the vapour phase. Such inhibitors and passivators may comprise, for example, a hydroxylamine chosen for volatility, pH and high temperature stability, and water solubility; a triazole derivative chosen for high temperature stability; an inhibited, volatile, water soluble high temperature alkyl methacrylate; a high temperature thiazole, a carboxylic acid such as octane-1-carboxylic acid, or decane-1,10-dicarboxylic acid; a mono basic acid; an amino ethyl alcohol; a tall oil fatty acid salt; or an alkoxy alcohol.

To commence an operational cycle, the door in the process chamber (10) is opened and a supporting platform, basket or framework within the chamber receives an article or articles to be washed. They are secured within the process chamber for rotation therein. A start button on the control system is actuated and the control system checks the temperature of the washing fluid within the supply tank heated by an immersion heater (20) to ensure that it is at or around 99° C. whereupon the door of the process chamber (10) is closed automatically. Rotation of the article or articles within the chamber commences. Pump P1 is energised to supply the washing fluid via V2 to the process chamber (10). V4 is simultaneously opened to allow the chamber (10), as it is filling, to vent back to the supply tank (11). The Pump P1 is initially started on slow speed using an inverter, as on initial start up there is no head of pressure in the system required to pump the solution at or above 100° C. on full speed. On filling the process chamber with solution, a head of pressure is established in the supply tank, and the temperature of the solution is increased to 100° C. or above. The head of pressure is controlled by V21, which is a pressure regulator set to maintain a pressure of around 0.14 bar in the system.

Rotational washing of the articles within the chamber (10) continues for a period of some 30 to 60 seconds after which it reaches high level sensor S1, drain valve V5 is opened to allow the process fluid to drain back into the supply tank. When low level sensor S2 detects that the process chamber is substantially empty then V5 closes to allow the chamber (10) to fill once again, until S1 detects that the chamber is full, and the process is repeated. This filling, washing and draining procedure may be repeated several times as required, typically between two and five times depending upon the degree of soil of the article or articles being washed. In the latter part of the washing cycle, or the last repeat as appropriate, the immersion heater (20) may be turned off to allow the temperature within the supply tank to fall below 100° C.

A final washing cycle is carried out by energising pump P1 for approximately 30 to 60 seconds. The temperature of the washing fluid will have fallen to something in the region of 95° C. to allow the pump to operate without the head of pressure in the supply tank.

Pump P1 then stops, V2 and V4 close and V5 remains open. The articles within the drum continue to be rotated while the chamber drains for a period of up to 30 seconds.

### Rinsing Cycle

A rinsing procedure then commences by opening valve V9 to allow pure rinsing water to be fed from the supply (16) to the process chamber (10) where it enters, preferably through a spray nozzle thus, while the articles are being rotated, to ensure that they are thoroughly rinsed to remove all residues of the washing fluid. This procedure may last for approximately 15 seconds and then V9 is closed whereupon the process chamber (10) drains via V5 to the supply tank and/or via V16 to waste. Determination of whether the rinsing water is drained to waste or to the supply tank is effected according to the level of liquid within the latter as determined by level sensors S3 and S4. Valve V7 may be opened if required to top up the supply tank (11) from the header tank (15).

### Drying Cycle

A drying procedure is then commenced by closing V5 and V16 and opening V3 and energising vacuum pump P2 for a predetermined period in the region of 30 to 60 seconds. By reducing the pressure within the chamber (10) to below atmospheric pressure the articles within the chamber are vacuum dried and any steam generated as a result of this is condensed by a vapour condenser (19) associated with the header tank (15).

The level sensor S5 in the header tank (15) causes valve V12 to open when the tank needs to be topped up.

Upon completion of the vacuum drying procedure P2 is stopped, V3 closes and V20 opens to reintroduce atmospheric pressure within the chamber (10) whereupon V5 opens for approximately 5 seconds to drain any residual water back to the tank. Again, V16 may be opened to drain the chamber (10) if the tank (11) is already filled to capacity.

Finally, rotation of the articles within the chamber is stopped with them in an upright position and the door to the chamber is opened to allow the washed and dried articles to be removed.

The water recycling system (13) is operated on a timer control, periodically to open valve V18 to draw a proportion of the washing fluid from the supply tank (11). In the recycling system (13) contaminants such as oil and grease are removed from the fluid, the concentrated residue being discharged to waste while the clean distillate passes to the water recovery tank (14) from which it can be returned to the supply tank (11) via return valve V14. This valve will open when high level sensor S7 on the tank (14) detects a full condition. Valve V13 provides a sample take off point.

The water recycling system (13) and the water recovery tank (14) are isolated from the supply tank (11) when it is pressurised.

The system also comprises a supply tank drain valve V10 and a vacuum pump isolating valve V11.

Periodically, chemical constituents within the drum (18) are fed by pump P3 and valve V17 to the supply tank to replenish the constituents of the washing fluid. A level sensor S6 provides an indication when the level in the drum (18) is low.

It is not intended to limit the invention to the above example only, many variations being possible within the scope of the invention as defined by the appended claims.

For example, vacuum drying as provided by pump P2 may be replaced by hot air drying within the process chamber (10). Alternatively, in certain cases it may be sufficient to allow washed articles to be dried once in the atmosphere when they are removed from the chamber. It will be appreciated that in accordance with the invention, the high temperature of the washing fluid at or above 100° C. may be maintained notwithstanding the need to pump such heated fluid to the chamber, by virtue of the head of pressure established within the supply tank. Without such over-pressure the pump P1 would not operate properly to pump the fluid in a continuous stream. Thus, by enabling the high temperature of the washing fluid, the washing cycle may be conducted quickly and efficiently, removing the more difficult soils experienced with some metal engineering components while avoiding the environmental problems of using strong alkaline detergents or solvents. Also, the level of temperature permits the washing cycle to be completed in the shortest possible time and, even with several washes, the entire washing, rinsing and drying cycle may, in many cases, be completed within ten minutes.

If required, a stored supply of compressed air may be valve-connected to the supply tank (11) to supplement the air vented from the chamber (10) to maintain the head of pressure in the tank (11) necessary to pump the fluid at or above 100° C.

The washing system may be used for hot curing of resin impregnated porous metal components. Such components contain resin which has been impregnated by vacuum and/or pressure into the pores of the components. Conventionally, curing has been carried out either in heated water at 90° C. to 95° C. or by using hot air at 120° C. to 130° C. or hot oil at a temperature in excess of 100° C. A problem with using hot air is the poor heat transfer of the air to the components which results in slower curing times and in the bleed out of the resin from the pores of the component, leaving surface residues and resulting in reduced sealing performance. A problem with using hot oil, typically at 110° C. to 120° C. is the need to control fumes and vapours given off from the oil, and also the need to clean the components after curing to remove the oil from the components.

Using the system of the present invention ensures that curing of the resin is completed fully and rapidly in hot aqueous washing fluid at 100° C. or above, the reduced bleed out of the resin giving better sealing results. The system therefore provides effective curing which has not previously been possible within short cycle times of less than five minutes. This is compared with ten minute cycles utilising conventional methods. Such faster cycle times are particularly advantageous with fully automated in-line production equipment used for the resin impregnation of castings. Typical applications for such castings include car and truck engine cylinder heads, blocks, transmission cases, fuel pumps, oil pumps, water pumps, air conditioning compressors and any other porous component which is required to withstand pressure in service.

We claim:

1. An aqueous washing system comprising a process chamber for receiving articles to be washed, a supply tank to contain a heated aqueous washing fluid, a pump and pipework to transfer the fluid from the supply tank to the process chamber, and means to establish a head of pressure over the fluid in the supply tank sufficient to enable the pump to transfer the fluid at a temperature of at least 100° C.

2. An aqueous washing system according to claim 1 including means for heating the washing fluid in the supply tank to a temperature at or above 100° C.

3. An aqueous washing system according to claim 1 including means for rotating or agitating articles within the process chamber.

4. An aqueous washing system according to claim 1 including valved pipework to return the washing fluid from the process chamber to the supply tank.

5. An aqueous washing system according to claim 4 including a filter to remove contaminants from the washing fluid prior to its return to the supply tank.

6. An aqueous washing system according to claim 1 wherein the means to establish a head of pressure over the fluid in the supply tank includes ducting to allow heated and expanded air from the process chamber to create a head of pressure in the supply tank above the washing fluid therein.

7. An aqueous washing system according to claim 1 including a vacuum pump to effect vacuum drying of articles within the process chamber.

8. An aqueous washing system according to claim 1 including a supply of aqueous rinsing fluid connected to the process chamber.

9. An aqueous washing system according to claim 1 including a cold water header tank connected to the supply tank.

10. An aqueous washing system according to claim 9 including a vapour condenser associated with the header tank.

11. An aqueous washing system according to claim 9 including means to control the temperature of the cold water in the header tank.

12. An aqueous washing system according to claim 1 including an aqueous fluid recycling system connected to the supply tank to remove contaminants from the washing fluid.

13. An aqueous washing system according to claim 1 including automatic timing and control means to effect cyclic operation of the system, and adjustable to suit the articles to be washed and the constituents of the washing fluid.

14. An aqueous washing system according to claim 1 including a stored supply of compressed air valve-connected to the supply tank to maintain the head of pressure in the tank.

15. A method of aqueous washing of articles in a process chamber comprising the steps of providing a supply of aqueous washing fluid in a supply tank, heating the fluid to a temperature of at least 100° C., establishing a head of pressure above the fluid in the supply tank, and pumping the fluid from the supply tank to the process chamber to wash articles therein.

16. A method according to claim 15 wherein the head of pressure over the fluid in the supply tank is created by ducting heated and expanded air from the process chamber into the supply tank above the fluid therein during filling of the process chamber.

17. A method according to claim 15 wherein a washing cycle is repeated a plurality of times, each time pressurising the supply tank, pumping the heated washing fluid to the process chamber, washing the articles in the process chamber, and returning the fluid to the supply tank.

18. A method according to claim 15 wherein the washing fluid contains at least one high-temperature, low-foam surfactant, at least one corrosion inhibitor and at least one multi-metal passivator.

19. A method according to claim 15 wherein the washing fluid contains at least one water-soluble vapour pressure modifier.

20. A method according to claim 15 wherein the washing fluid contains at least one viscosity and surface tension reducer.

21. A method according to claim 15 including providing a stored supply of compressed air and feeding the compressed air to the supply tank to maintain the head of pressure above the fluid therein.
